(19) United States
(12) Patent Application Publication
(10) Pub. No.: US 2005/0200757 A1
(43) Pub. Date: Sep. 15, 2005

(54) Method and apparatus for digital video reconstruction

(76) Inventors: Alberta Pica, Allentown, NJ (US); Hui Cheng, Bridgewater, NJ (US); Tao Chen, Diamond Bar, CA (US); Jeffery Lubin, Princeton, NJ (US)

Correspondence Address: MOSER, PATTERSON & SHERIDAN, LLP;/SARNOFF CORPORATION, 595 SHREWSBURY AVENUE, SUITE 100, SHREWSBURY, NJ, 07702, US

(21) Appl. No.: 11/042,772

(22) Filed: Jan. 24, 2005

Related U.S. Application Data
(60) Provisional application No. 60/538,519, filed on Jan. 23, 2004.

(51) Int. Cl. H04N 7/12

(52) U.S. Cl. 348/390.1

(57) ABSTRACT

A method and apparatus for reconstructing digital video is provided. In one embodiment, a method for transmitting an original video stream including at least one frame includes segmenting the frame into a plurality of regions, encoding each region in accordance with one of a plurality of available interpolation algorithms that provides minimal distortion the region, and providing a signal containing information that enables a decoder to identify the interpolation algorithms corresponding to each of the regions. This information enables a decoder to enhance a base layer video stream while minimizing the amount of information that must be provided to the decoder in order to perform the enhancement.

### CROSS REFERENCE TO RELATED APPLICATIONS

This application claims the priority of U.S. Provisional Patent Application No. 60/538,519, filed Jan. 23, 2004 (entitled “Supervised Multi-Layer Adaptive Reconstruction Technique For Video Coding”), which is herein incorporated by reference.

### FIELD OF THE INVENTION

The present invention relates generally to video processing, and relates more particularly to the compression and decompression of digital video.

### BACKGROUND OF THE INVENTION

While digital video compression has advanced significantly over the last decade, even further improvement of compression efficiency is needed in order to deliver entertainment video through Internet or wireless channels, where bandwidth is typically most limited (e.g., approximately 500 kilobits per second for a DSL channel).

One known way to reduce the bit rate of digital video is to reduce the spatial resolution (i.e., number of pixels) of the original video before compression, and then interpolate the decoded video back to the original resolution at the decoder. However, this technique noticeably degrades the quality of the reconstructed video. For example, the decimation (reduction in resolution) of the original video causes the loss of high-frequency information, resulting in the blurring of and/or loss of detail in the reconstructed video (e.g., because all post-decimation processing is performed on a low-resolution video). In addition, the subsequent interpolation of a decimated video typically magnifies coding artifacts (e.g., edge ringing, blocking and the like), particularly at low bit rates, because the decimation/interpolation algorithms are optimized independent of the video compression scheme.

Thus, there is a need in the art for a method and apparatus for digital video reconstruction.

### SUMMARY OF THE INVENTION

In one embodiment, a method and apparatus for reconstructing digital video is provided. In one embodiment, a method for transmitting an original video stream including at least one frame includes segmenting the frame into a plurality of regions, encoding each region in accordance with one of a plurality of available interpolation algorithms that provides minimal distortion the region, and providing a signal containing information that enables a decoder to identify the interpolation algorithms corresponding to each of the regions. This information enables a decoder to enhance a base layer video stream while minimizing the amount of information that must be provided to the decoder in order to perform the enhancement.

### BRIEF DESCRIPTION OF THE DRAWINGS

So that the manner in which the above recited embodiments of the invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating one embodiment of an encoding system for encoding digital video according to the present invention;

FIG. 2 is a block diagram illustrating one embodiment of a control vector estimation module according to the present invention;

FIG. 3 is a block diagram illustrating one embodiment of a corresponding decoding system for decoding digital video according to the present invention;

FIG. 4A depicts a frame of an original video stream;

FIG. 4B depicts a segmented frame corresponding to the frame of FIG. 4A; and

FIG. 5 is a high level block diagram of the present method for reconstructing digital video that is implemented using a general purpose computing device.

To facilitate understanding, identical reference numerals have been used, where possible, to designate identical elements that are common to the figures.

### DETAILED DESCRIPTION

In one embodiment, the present invention is a method an apparatus for digital video reconstruction. In one embodiment, the present invention provides a method by which an encoder segments frames of an original video stream into a plurality of regions, and then encodes each region in accordance with a different interpolation/post-processing algorithm. Information regarding which interpolation/post-processing algorithm to use for each region of a frame is relayed to a receiving decoder, which uses this information to restore an encoded and/or sub-sampled version of the original video stream to near-original quality (e.g., resolution).

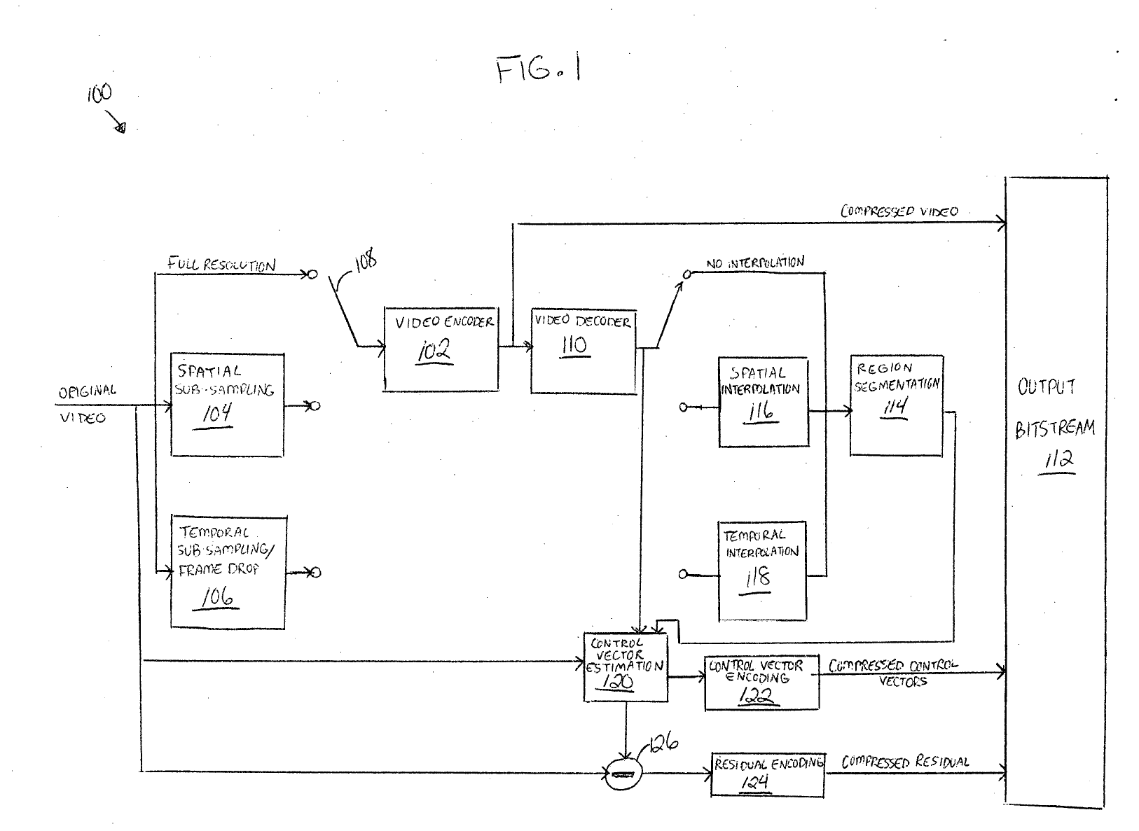

FIG. 1 is a block diagram illustrating one embodiment of an encoding system 100 for encoding digital video according to the present invention. FIG. 1 also serves as a flow diagram illustrating one embodiment of a method by which the encoding system 100 encodes digital video.

A stream of original video content (e.g., comprising a plurality of individual frames) is received by the encoding system 100, at which point the encoding system 100 determines how to treat each individual frame of the video stream before encoding. In one embodiment, an individual frame may be processed in full resolution, may be spatially sub-sampled (e.g., “decimated” by a fixed factor) to a lower resolution, or may be temporally sub-sampled (e.g., dropped). In one embodiment, a determination concerning how to treat an individual frame is made in accordance with at least one of a predetermined fixed Group of Picture (GOP) pattern, rate-distortion optimization, or characteristics of the original video content (e.g., in a series of static or minimal motion frames, some individual frames can be temporally sub-sampled; in a series of fast-moving or blurred frames, some individual frames can be spatially sub-sampled). In the case where the frame is to be processed in full resolution, the frame proceeds directly to a video encoder 102 for further processing. Alternatively, if the frame is to be spatially sub-sampled, the frame proceeds to a spatial sub-sampling module 104 and then to the video encoder 102. If the frame is to be temporally sub-sampled, the frame proceeds to a temporal sub-sampling module 106 and then to the video encoder 102. In one embodiment, a switch 108 may be incorporated in the encoding system 100 to selectively couple the video encoder 102 to the video stream containing the sub-sampled and/or the original (e.g., full resolution) frames.

The video encoder 102 is adapted to compress (e.g., encode) the video stream containing the original or sub-sampled frames. In one embodiment, the video encoder 102 is any video encoder, including proprietary video encoders and standardized video coders such as a Moving Picture Experts Group (MPEG)-2, an MPEG-4 encoder or an H.264 (MPEG-4 part 10 or JVT) encoder. The video encoder 102 outputs the compressed video stream as a base layer video stream to a video decoder 110. In addition, the same base layer video stream is output, unaltered, directly to the receiving decoder as compressed video in an output bitstream 112. This base layer video stream provides a basic-resolution video stream that may be enhanced at the receiving decoder side using additional information (e.g., control vectors and/or residuals) provided by the encoding system 100, as described in further detail below.

The video decoder 110 is adapted to receive the base layer video stream from the video encoder 102 and to interpolate each frame of the base layer video stream by a pre-defined interpolation algorithm that is known by both the video encoder 102 and the video decoder 110. In one embodiment, the pre-defined interpolation algorithm is at least one of: edge-based interpolation with peaking, bilinear interpolation, bilinear interpolation followed by Gaussian smoothing with a standard deviation of 1.0 and bilinear interpolation followed by Gaussian smoothing with a standard deviation of 3.0. Each decoded frame of the base layer video stream then proceeds to a region segmentation module 114 for further processing, as described in greater detail below.

Thus, if a frame of the base layer video stream was received by the video encoder 102 as a full-resolution frame, no interpolation algorithm needs to be applied by the video decoder 110, and the frame proceeds directly to the region segmentation module 114. Alternatively, if the frame of the base layer video stream was received by the video encoder 102 as a spatially sub-sampled frame, the video decoder 110 applies the corresponding interpolation algorithm (e.g., at a spatial interpolation module 116) in order to “up-sample” the frame to its original resolution before the frame proceeds to the region segmentation module 114. If the frame of the base layer video stream was received by the video encoder 102 as a temporally sub-sampled or dropped frame, the video decoder 110 applies a temporal interpolation (e.g., at a temporal interpolation module 118) in order to restore the frame before the frame proceeds to the region segmentation module 114.

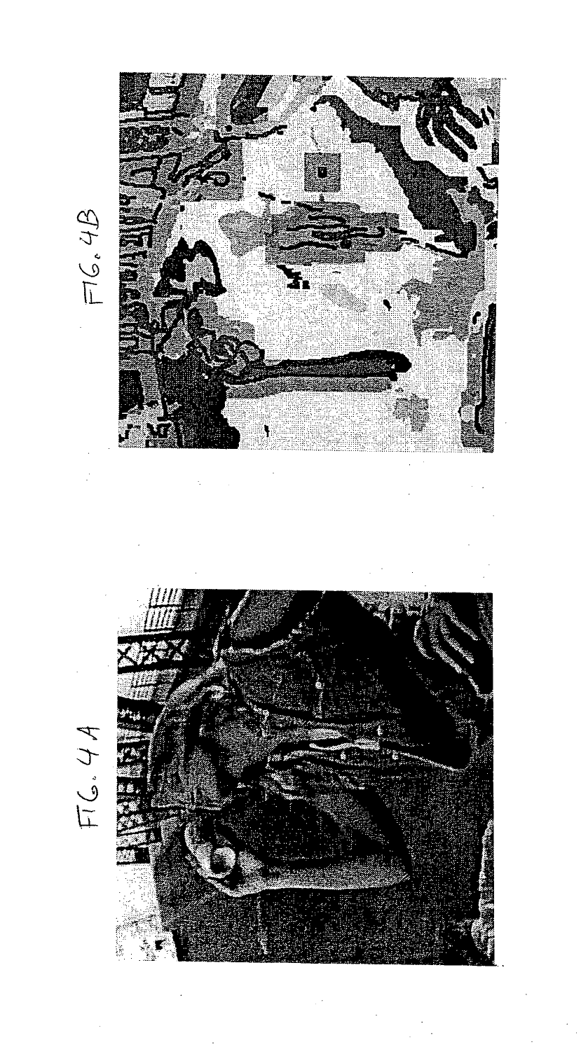

The region segmentation module 114 is adapted to segment the interpolated frames of the base layer video stream into a plurality of regions. In one embodiment, the region segmentation module 114 segments an interpolated frame into three main types of regions: (1) edge regions, which contain strong edges and pixels adjacent to strong edges; (2) ringing regions, which contain pixels close to strong edges that do not belong to edge regions; and (3) other tertiary regions containing pixels that do not belong to either edge or ringing regions. This last category of regions may be further segmented into sub-regions according to properties of the pixels (e.g., including the colors of the pixels, the textures of the pixels, pixels comprising high frequency texture regions or human faces and pixels comprising slowly changing regions or sweeps). FIGS. 4A and 4B depict, respectively, a frame of an original video stream and a corresponding segmented frame comprising approximately eighty-nine separate regions. The segmented regions are then delivered to a control vector estimation module 120.

The control vector estimation module 120 is adapted to estimate the control vectors that will enable the receiving decoder to interpolate the base layer video stream to the resolution of the original video stream, i.e., using a plurality of interpolation/post-processing algorithms that are respectively defined for each individual region of each frame. In addition, the control vector estimation module 120 is also adapted to receive the original video stream and the decoded (but un-interpolated) stream from the video decoder 110, and to estimate control vectors for both the original video stream and the decoded stream. All of these control vectors are then compressed by a control vector encoding module 122, which then outputs the compressed control vectors to the output bitstream 112. In one embodiment, the control vector encoding module 122 compresses control vectors using at least one of entropy-based coding and prediction-based coding.

In addition, the control vector estimation module 120 outputs prediction residual to a residual computation module 126, which computes the reconstructed frame and the corresponding residuals. In some embodiments, it may be desirable to code and transmit residual signals to the receiving decoder in order to further enhance the quality of the reconstructed video. In one embodiment, the residual computation module 126 computes residuals for at least two particular regions of a frame: blurred edges and textures, both of which contain relatively high-frequency information that tends to be lost during sub-sampling.

The computed residuals are then encoded by a residual encoding module 124 and output as compressed residuals to the output bitstream 112. In one embodiment, the residual encoding module 124 implements an edge-segmentation-based one-dimensional discrete cosine transformation (DCT) for coding residual signals associated with high-contrast edges and adjacent pixels in a frame. Edges are first segmented into either horizontal or vertical edges, and then the residual signal is re-arranged along the edge direction and one-dimensional DCT transformed. The one-dimensional DCT coefficients are then quantized and entropy encoded.

In another embodiment, residuals of each region are fitted with a set of high-frequency texture models (e.g., a Gaussian noise model, an Ising model or other Markov random field models). The best model is then selected, and its index and parameters are sent to the receiving decoder to guide texture reconstruction of the corresponding region. This enables the restoration of high-frequency textures (e.g., fine details) lost during sub-sampling without significantly increasing the bit rate of the output bitstream 112.

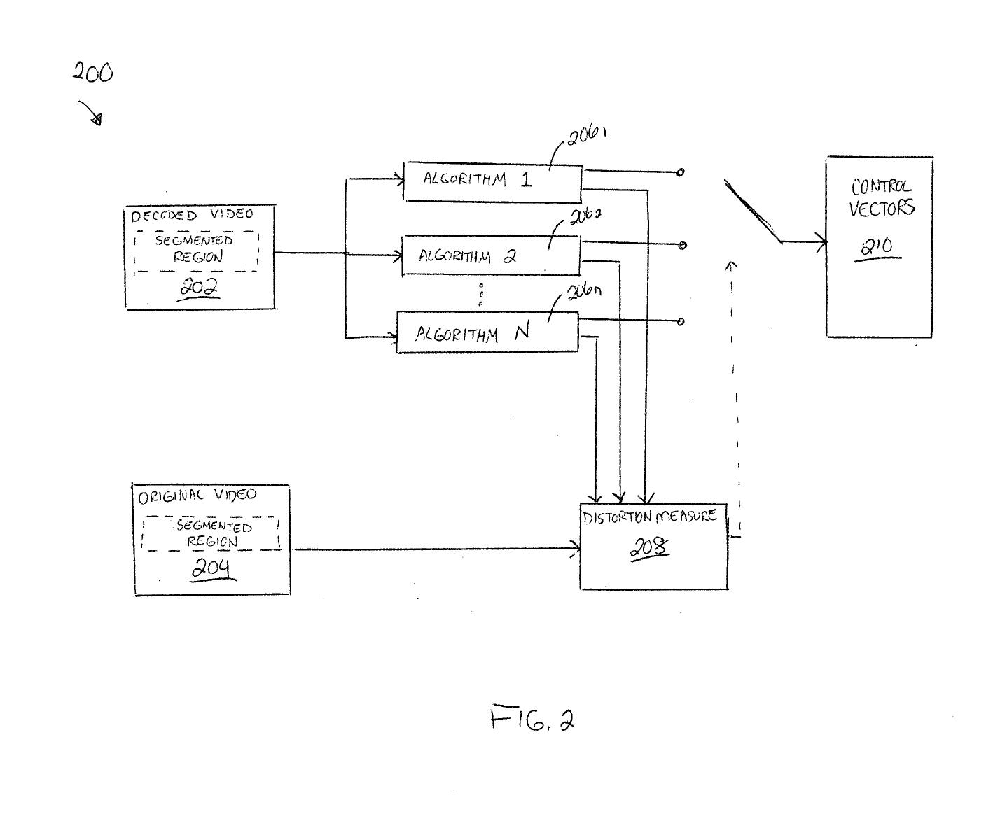

FIG. 2 is a block diagram illustrating one embodiment of a control vector estimation module 200 according to the present invention. FIG. 2 also serves as a flow diagram illustrating one embodiment of a method by which the control vector estimation module 200 estimates the control vectors that will enable the receiving decoder to reconstruct the frames of the original video stream, i.e., using the interpolation/post-processing algorithms that are defined for each respective segmented region of each frame. The control vector estimation module 200 may be implemented by the encoding system 100 in place of the control vector estimation module 120.

Thus, the control vector estimation module 200 receives both decoded video 202 (e.g., from the video decoder 110 of the encoding system 100) and the original video stream 204, both of which are segmented into a plurality of regions (e.g., by the region segmenting module 114).

Each region of the decoded video is processed in accordance with at least one of a plurality of available interpolation/post-processing algorithms 206₁-206ₙ (hereinafter collectively referred to as “interpolation/post-processing algorithms 206”). In one embodiment, these interpolation/post-processing algorithms 206 are selected to suppress different types of artifacts associated with interpolation and low bit-rate video encoding. As discussed above, in one embodiment, this plurality of interpolation/post-processing algorithms 206 includes at least one of: edge-based interpolation with peaking (e.g., for sharpening blurred edge regions); bilinear interpolation (e.g., for regions without noticeable blurring, blocking and/or ringing artifacts); bilinear interpolation followed by Gaussian smoothing with a standard deviation of 1.0 (e.g., for suppressing blocking artifacts and weak ringing artifacts); bilinear interpolation followed by Gaussian smoothing with a standard deviation of 3.0 (e.g., for removing severe ringing around string edge regions, such as ringing around text strokes). In other embodiments, any other interpolation/post-processing algorithm that can improve the quality of reconstructed video can be used.

The results (e.g., reconstructed videos) from each application of the interpolation/post-processing algorithms 206 are then provided, along with the original video 204, to a distortion measurement module 208. The distortion measurement module 208 calculates the distortion between the segmented regions in the original video and the corresponding segmented regions in each of the reconstructed videos. The distortion measurement module then determines, for each segmented region, which interpolation/post-processing algorithm yields the reconstructed video with the least amount of distortion (e.g., deviation from the original video). The indices and parameters for each segmented region's best interpolation/post-processing algorithm are then provided as control vectors 210 to the control vector encoding module 122.

Thus, by segmenting a frame of a video stream into a plurality of regions, and encoding each individual region of each frame in accordance with an interpolation/post-processing algorithm that provides the best results for that region, a decoded video can be ultimately produced by the receiving decoder that most closely resembles the original video (e.g., provides minimal distortion). Moreover, because this information is provided in the form of control vectors (which typically consume a lesser number of bits than do coded residuals) to the receiving decoder, the bandwidth required to transmit the necessary information remains relatively low. Thus, scalable video coding and reconstruction can be achieved that is at least comparable to reconstruction achieved by conventional methods.

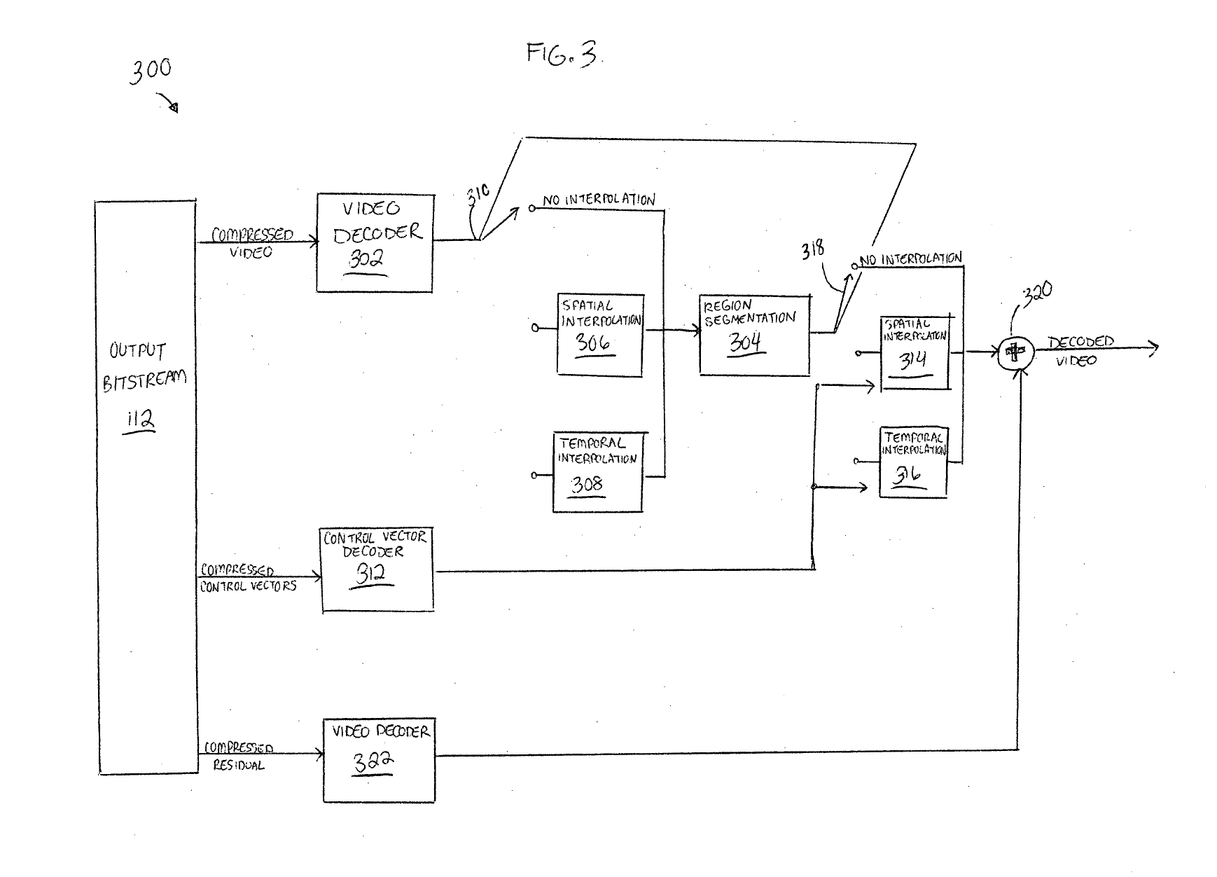

FIG. 3 is a block diagram illustrating one embodiment of a corresponding decoding system 300 for decoding digital video according to the present invention, e.g., for use by a receiving decoder. FIG. 3 also serves as a flow diagram illustrating one embodiment of a method by which the decoding system 300 decodes digital video.

The output bitstream 112 produced by the encoding system 100 is received by the decoding system 300 on the receiver end. As discussed with respect to FIG. 1, the output bitstream 112 comprises three main components: a base layer bitstream (e.g., embodied in compressed video), compressed control vectors and compressed residuals. The base layer bitstream is sent to a first video decoder 302, which decodes the base layer bitstream. In accordance with this decoding process, the decoded base layer bitstream may be provided to an appropriate interpolation module for interpolation using the pre-defined interpolation algorithm (e.g., as used by the video encoder 102 of the encoding system 100 to sub-sample the original video stream). Thus, if the original video stream was not sub-sampled, no interpolation is necessary, and the decoded base layer bitstream proceeds directly to a region segmentation module 304 for further processing, as discussed in greater detail below. If the original video stream was spatially sub-sampled, the base layer bitstream is interpolated using a first spatial interpolation module 306. If the original video stream was temporally sub-sampled, the base layer bitstream is interpolated using a first temporal interpolation module 308. In one embodiment, a switch 310 may be incorporated in the decoding system 300 to selectively couple the video decoder 302 to the appropriate interpolation module 306 or 308 (or directly to the region segmentation module 304).

The region segmentation module 304 is adapted to segment each frame of the interpolated base layer bitstream into a plurality of regions corresponding to the regions into which the original video stream was segmented by the region segmentation module 114 of the encoding system 100. These segmented regions are then individually interpolated using the interpolation algorithms respectively defined for each segmented region by the region segmentation module 114 of the encoding system 100, as described in further detail below.

The compressed control vectors of the output bitstream 112 are decoded by a control vector decoder 312. As discussed above, the decoded control vectors provide the interpolation/post-processing algorithms that are needed to reconstruct the plurality of regions into which the interpolated base layer bitstream has been segmented. Thus, the decoded control vectors are provided, along with the interpolated base layer bitstream, to an appropriate interpolation module. For example, if a segmented region of the original video stream was processed at full resolution, no interpolation is necessary, and the interpolated base layer bitstream and the decoded control vectors may be provided directly to a residual augmentation module 320. If a segmented region of the original video stream was spatially sub-sampled, the interpolated base layer bitstream and the decoded control vectors are processed using a second spatial interpolation module 314 prior to being provided to the residual augmentation module 320. If a segmented region of the original video stream was temporally sub-sampled, the interpolated base layer bitstream and the decoded control vectors are processed using a second temporal interpolation module 316 prior to being provided to the residual augmentation module 320. In one embodiment, a switch 318 may be incorporated in the decoding system 300 to selectively couple the region segmentation module 304 to the appropriate interpolation module 314 or 316 (or directly to the region segmentation module 304). The switch 318 is synchronized with the switch 310, e.g., so that the appropriate interpolation module is consistently selected at all stages of decoding.

Finally, the compressed residuals of the output bitstream 112 are decoded by a second video decoder 322. The decoded residuals are provided, along with the appropriately interpolated base layer bitstream (e.g., as interpolated in accordance with the decoded control vectors), to the residual augmentation module 320, which processes the decoded residuals and the interpolated base layer bitstream to produce decoded video corresponding to the original video content.

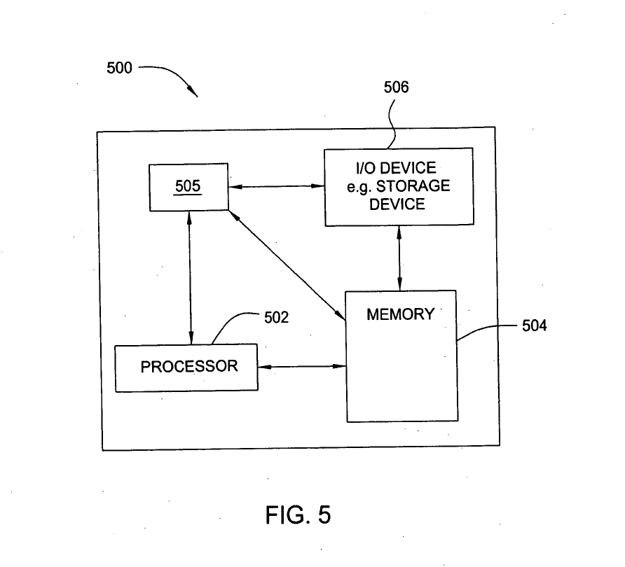

FIG. 5 is a high level block diagram of the present method for reconstructing digital video that is implemented using a general purpose computing device 500. In one embodiment, a general purpose computing device 500 comprises a processor 502, a memory 504, a digital video reconstruction module 505 and various input/output (I/O) devices 506 such as a display, a keyboard, a mouse, a modem, and the like. In one embodiment, at least one I/O device is a storage device (e.g., a disk drive, an optical disk drive, a floppy disk drive). It should be understood that the digital video reconstruction module 505 can be implemented as a physical device or subsystem that is coupled to a processor through a communication channel.

Alternatively, the digital video reconstruction module 505 can be represented by one or more software applications (or even a combination of software and hardware, e.g., using Application Specific Integrated Circuits (ASIC)), where the software is loaded from a storage medium (e.g., I/O devices 1206) and operated by the processor 502 in the memory 504 of the general purpose computing device 500. Thus, in one embodiment, the digital video reconstruction module 505 for reconstructing digital video described herein with reference to the preceding Figures can be stored on a computer readable medium or carrier (e.g., RAM, magnetic or optical drive or diskette, and the like).

Thus, the present invention represents a significant advancement in the field of video processing. A method is provided by which a sending encoder segments frames of an original video stream into a plurality of regions, and then encodes each region in accordance with a different interpolation/post-processing algorithm. Information regarding which interpolation/post-processing algorithm to use for each region of a frame is relayed to a receiving decoder, which uses this information to restore an encoded and/or sub-sampled version of the original video stream to near-original quality (e.g., resolution). A significant amount of bandwidth is thereby conserved by transmitting this relatively

While the foregoing is directed to embodiments of the invention, other and further embodiments of the invention may be devised without departing from the basic scope thereof, and the scope thereof is determined by the claims that follow.

1. A method for transmitting an original video stream comprising at least one frame, the method comprising:
segmenting said at least one frame into a plurality of regions;
encoding each of said plurality of regions in accordance with a respective one of a plurality of interpolation algorithms that provides minimal distortion of a corresponding region; and
providing a signal containing information that enables a decoder to identify said respective one of said plurality of interpolation algorithms corresponding to each of said plurality of regions.

2. The method of claim 1, further comprising:
providing a compressed base layer video stream, where said information contained in said signal enables said base layer video stream to be enhanced.

3. The method of claim 1, wherein said plurality of interpolation algorithms comprises at least one of: edge-based interpolation with peaking, bilinear interpolation and bilinear interpolation followed by Gaussian smoothing.

4. The method of claim 3, wherein said bilinear interpolation followed by Gaussian smooth has a standard deviation of at least approximately 1.0.

5. The method of claim 1, wherein said plurality of regions comprises at least one of: edge regions, ringing regions and tertiary regions.

6. The method of claim 5, wherein said edge regions comprise strong edges of said at least one frame and pixels of said at least one frame that are adjacent to said strong edges.

7. The method of claim 5, wherein said ringing regions comprise pixels of said at least one frame that are close to strong edges but that do not belong to said edge regions.

8. The method of claim 5, wherein said tertiary regions are further segmented into a plurality of sub-regions.

9. The method of claim 8, wherein each of said plurality of sub-regions is segmented based on at least one of color of pixels and texture of pixels in said plurality of sub-regions.

10. A computer readable medium containing an executable program transmitting an original video stream comprising at least one frame, where the program performs the steps of:
segmenting said at least one frame into a plurality of regions;
encoding each of said plurality of regions in accordance with a respective one of a plurality of interpolation algorithms that provides minimal distortion of a corresponding region; and
providing a signal containing information that enables a decoder to identify said respective one of said plurality of interpolation algorithms corresponding to each of said plurality of regions.

11. The computer readable medium of claim 10, further comprising:
providing a compressed base layer video stream, where said information contained in said signal enables said base layer video stream to be enhanced.

12. The computer readable medium of claim 10, wherein said plurality of interpolation algorithms comprises at least one of: edge-based interpolation with peaking, bilinear interpolation and bilinear interpolation followed by Gaussian smoothing.

13. The computer readable medium of claim 12, wherein said bilinear interpolation followed by Gaussian smooth has a standard deviation of at least approximately 1.0.

14. The computer readable medium of claim 10, wherein said plurality of regions comprises at least one of: edge regions, ringing regions and tertiary regions.

15. The computer readable medium of claim 14, wherein said edge regions comprise strong edges of said at least one frame and pixels of said at least one frame that are adjacent to said strong edges.

16. The computer readable medium of claim 14, wherein said ringing regions comprise pixels of said at least one frame that are close to strong edges but that do not belong to said edge regions.

17. The computer readable medium of claim 14, wherein said tertiary regions are further segmented into a plurality of sub-regions.

18. The computer readable medium of claim 17, wherein each of said plurality of sub-regions is segmented based on at least one of color of pixels and texture of pixels in said plurality of sub-regions.

19. Apparatus for transmitting an original video stream comprising at least one frame, the apparatus comprising:
means for segmenting said at least one frame into a plurality of regions;
means for encoding each of said plurality of regions in accordance with a respective one of a plurality of interpolation algorithms that provides minimal distortion of a corresponding region; and
means for providing a signal containing information that enables a decoder to identify said respective one of said plurality of interpolation algorithms corresponding to each of said plurality of regions.

20. The apparatus of claim 19, wherein said plurality of interpolation algorithms comprises at least one of: edge-based interpolation with peaking, bilinear interpolation and bilinear interpolation followed by Gaussian smoothing.
